(19) United States
(12) Patent Application Publication
(10) Pub. No.: US 2022/0277293 A1
(43) Pub. Date: Sep. 1, 2022

(54) MODIFYING A USER INTERFACE TO MAKE A CARD ASSOCIATED WITH AN ENTITY AVAILABLE AT A RELEVANT TIME

(71) Applicant: Capital One Services, LLC, McLean, VA (US)

(72) Inventor: Rizwan MUJEEBUDDIN, Chester, VA (US)

(21) Appl. No.: 17/186,809

(22) Filed: Feb. 26, 2021

(51) Int. Cl. G06Q 20/34; G06F 16/958; G06Q 30/02

(52) U.S. Cl. CPC G06Q 20/342; G06Q 20/351; G06Q 20/348; G06Q 20/3433; G06F 16/986; G06Q 30/0233

(57) ABSTRACT

In some implementations, a device may detect that the web page is associated with an exchange associated with an entity. The device may transmit, to a server, web page information that identifies at least one of the entity associated with the web page, or an amount of the exchange associated with the entity. The device may receive, from the server, presentation information that identifies card information for one or more cards that are associated with the entity. Card information may identify information associated with resources associated with the card. The device may modify the document used to generate the web page based on the presentation information to cause the card information for the one or more cards to be provided for display via the web page. The device may display the web page based on modifying the document used to generate the web page.

### BACKGROUND

A graphical user interface is a form of user interface that allows users to interact with electronic devices. A web browser may provide a graphical user interface that presents web pages. A user may navigate to a web page by entering a web address into an address bar of the web browser and/or by clicking a link displayed via another web page. Navigation to a web page may consume resources of a client device on which the web browser is installed, may consume resources of a web server that serves the web page to the client device, and may consume network resources used for communications between the client device and the web server.

### SUMMARY

In some implementations, a non-transitory computer-readable medium storing a set of instructions for modifying a document object model of a user interface to be provided for presentation that makes resources of a card associated with an entity available at a relevant time includes one or more instructions that, when executed by one or more processors of a device, cause the device to: detect that the user interface, to be provided for presentation by the device, is to display a checkout page associated with the entity; identify exchange information associated with a first exchange indicated by the checkout page, the exchange information including an amount of the first exchange; transmit, to a server device, user interface information that indicates the entity and the exchange information; receive, from the server device, presentation information that indicates card information for the card associated with the entity based on transmitting the user interface information, wherein the card information indicates information associated with the resources of the card; modify the document object model of the user interface based on the presentation information to cause an indication of the card information to be provided for presentation via the user interface; and provide the user interface for presentation by the device based on modifying the document object model.

In some implementations, a method of modifying a document used to generate a web page to be provided for display by a device includes detecting, by a browser extension executing on the device, that the web page is associated with an entity and an exchange associated with the entity; transmitting, by the browser extension and to a server, web page information that identifies at least one of: the entity associated with the web page, or an amount of the exchange associated with the entity; receiving, by the browser extension and from the server, presentation information that identifies card information for one or more cards that are associated with the entity, wherein card information associated with a card, of the one or more cards, identifies information associated with resources associated with the card; modifying, by the browser extension, the document used to generate the web page based on the presentation information, wherein modifying the document causes the card information for the one or more cards to be provided for display via the web page; and displaying, by the device, the web page based on modifying the document used to generate the web page.

In some implementations, a system includes one or more memories and one or more processors, communicatively coupled to the one or more memories, configured to: receive, from a web browser extension executing on a first client device, information that identifies: an entity associated with a graphical user interface being presented for display by a web browser executing on the first client device, and transaction information that is being presented for display by the web browser; identify one or more cards based on the information using a data structure that stores card information, wherein the one or more cards are associated with users that are different than a user of the first client device; determine, from the one or more cards, a card to be provided to the first client device; and transmit, to the first client device, card information that identifies information associated with resources of the card.

### BRIEF DESCRIPTION OF THE DRAWINGS

FIGS. 1A-1E are diagrams of an example implementation relating to modifying a user interface.

FIG. 2 is a diagram of an example environment in which systems and/or methods described herein may be implemented.

FIG. 3 is a diagram of example components of one or more devices of FIG. 2.

FIG. 4 is a flowchart of an example process relating to modifying a user interface.

### DETAILED DESCRIPTION

The following detailed description of example implementations refers to the accompanying drawings. The same reference numbers in different drawings may identify the same or similar elements.

A gift card is a prepaid stored value card that can be redeemed at an entity (e.g., a merchant) or at one or more entities. A gift card can be used as an alternative to cash or credit/debit purchases at a particular entity (or a set of entities). A gift card may also be referred to as a gift certificate, a gift voucher, and/or a gift token. However, gift cards often go unused, resulting in a waste of the prepaid stored value on the gift card. For example, a user may receive a gift card associated with an entity or merchant that the user does not often visit or shop at or a user may forget about the gift card and not use it. Moreover, in some cases, gift cards may expire after a certain amount of time (e.g., according to an expiration date of the card). Therefore, if the user does not use the gift card prior to the expiration date of the gift card, the prepaid stored value on the gift card may be wasted.

In some cases, a gift card exchange platform can be provided that offers gift card owners a monetary value (e.g., usually significantly less than the prepaid stored value on the gift card) to purchase the gift card from the gift card owner. The gift card exchange platform may resell the gift card to other users (e.g., for less than the prepaid stored value on the gift card, but more than the monetary value paid to the gift card owner). This enables the gift card owner to receive some value for the gift card and to avoid forgetting about or not using the gift card. However, such gift card exchange platforms are provided as standalone web pages. When a user browses web pages or other user interfaces to find information relevant to the user, the user may need to navigate through multiple web pages and/or may need to input some personal information about the user before the user can find the information sought by the user. For example, a user wishing to purchase a gift card may need to navigate multiple web pages to identify the web page of the gift card exchange platform, navigate the web page of the gift card exchange platform to view multiple gift cards associated with multiple merchants, identify the gift cards associated with merchant(s) relevant to the user, identify gift cards having a prepaid stored value (e.g., balance) in a range desired by the user, indicate a desire to receive (e.g., purchase) a relevant gift card, input personal information (e.g., the user's name, address, and payment information), and/or confirm the personal information and the desire to purchase the relevant gift card. Moreover, once the user purchases the relevant gift card from the gift card exchange platform, the problems discussed above (e.g., the risk of forgetting about or not using the gift card) are still present, resulting in a waste of the prepaid stored value on the gift card.

Navigating through a large number of web pages to find relevant information creates a poor user experience, consumes excessive computing resources (e.g., processing resources and memory resources) that are needed for a client device to generate and display the web pages and that are needed for one or more server devices to serve the web pages to the client device, and consumes excessive network resources that are needed for communications between the client device and the server device. Some implementations described herein enable a relevant gift card to be presented to a user at a relevant time without requiring the user to navigate through a large number of web pages. For example, a relevant gift card can be presented or offered via a web page or other user interface (e.g., on a client device or on a user device) at a point of sale (e.g., at a time when a user is performing a transaction with an entity). The gift card may be eligible to be used at the entity associated with the point of sale and may be based on transaction information (e.g., a transaction amount) of the present transaction. The user can purchase the gift card via the web page or other user interface and the gift card can be immediately applied (e.g., by the user or automatically by a platform providing the gift card) to the present transaction.

To enable a relevant gift card to be presented to a user at a relevant time without requiring the user to navigate through a large number of web pages, some systems described herein may enable gift card owners to provide or otherwise make available gift cards that the gift card owner wishes to sell. The system may maintain a database of gift cards and may actively monitor and/or update the database (e.g., removing expired gift cards and/or updating balances of gift cards). The system may detect that a user interface is associated with a first transaction associated with an entity (e.g., at a point of sale web page or at a transaction terminal). The system may identify transaction information (e.g., an entity associated with the transaction and/or a transaction amount) associated with the transaction. The system may parse and/or search the database of gift cards to identify one or more relevant gift cards (e.g., based on the transaction information). The system may provide and/or offer a relevant gift card via the user interface that can be applied (e.g., by the system or the user) to the transaction. For example, the system may insert code into a document object model of a web page to make the gift card easier to access using a client device (e.g., by eliminating excessive web page navigation using the client device).

As indicated above, the systems described herein can conserve processing resources, memory resources, and network resources. Furthermore, the systems described herein make data easier to access by enhancing a user interface, thereby improving a user experience, enhancing user-friendliness of a client device and the user interface, and improving the ability of a user to use the client device. In some implementations, gift card information is presented in a unified manner at a relevant time (e.g., at a point of sale) via a user interface (as opposed to a scenario where gift card information is presented on separate web pages of different platforms at irrelevant times), thereby further improving access to the gift card information. Additionally, the systems described herein can improve data security by reducing a quantity of times that a client device transmits personal information of a user via a network.

As a result, a user may be more likely to purchase the gift card via the system because the gift card is presented at a point of sale (e.g., where the gift card can be immediately applied) and the user does not have to navigate multiple web pages to locate and/or purchase the gift card. Moreover, because the gift card can be applied immediately to a present transaction, the risk that the gift card goes unused is reduced or eliminated. Therefore, systems described herein increase the likelihood that an unwanted gift card (e.g., of a gift card owner) is purchased by a relevant user (e.g., a user who is shopping at an entity associated with the unwanted gift card) because the gift card is provided or offered to the user at a point of sale associated with a transaction at the entity. Additionally, systems described herein reduce or eliminate the likelihood that the prepaid stored value of the gift card is wasted because the gift card can be applied to the present transaction (e.g., eliminating a risk that the user forgets to use the gift card or that the gift card is not used before an expiration date).

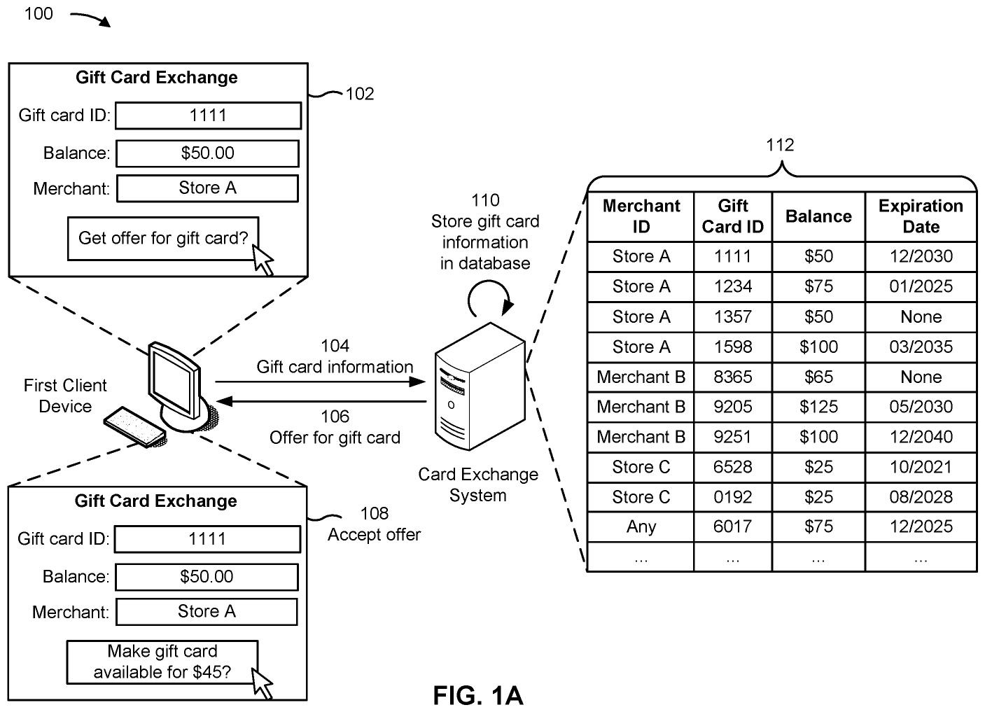

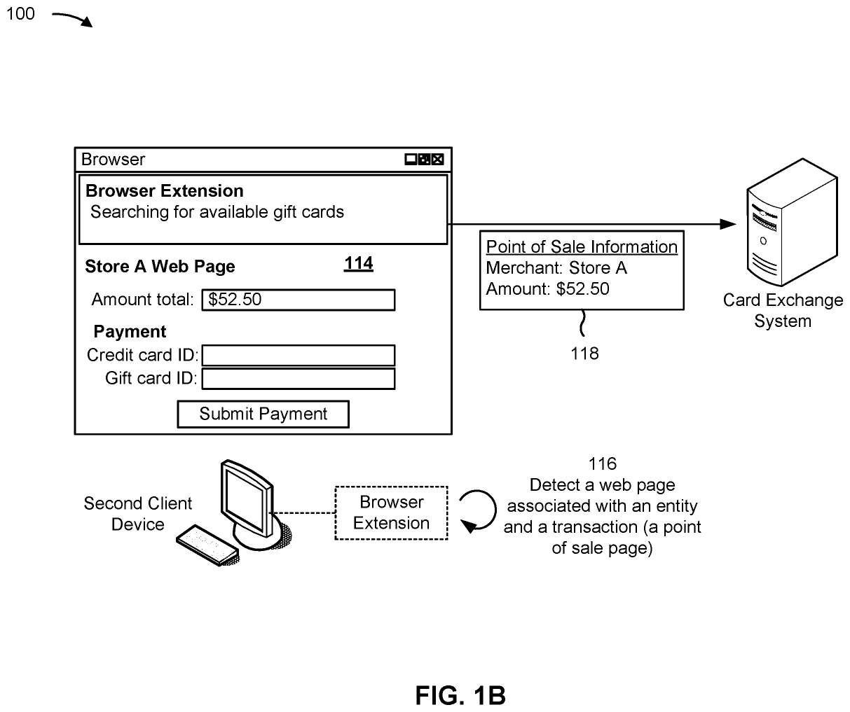

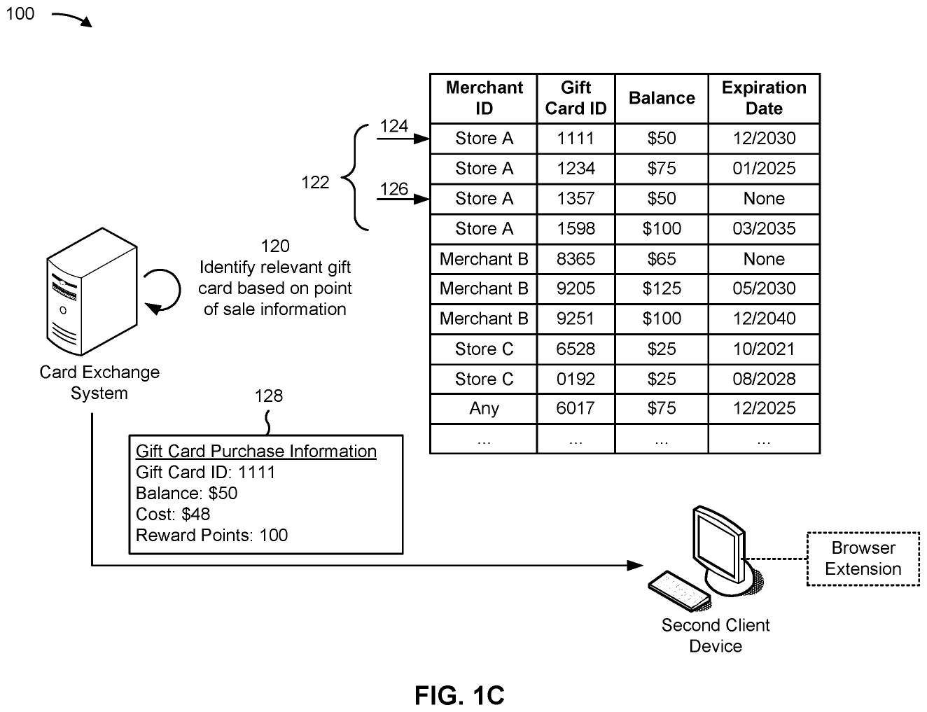

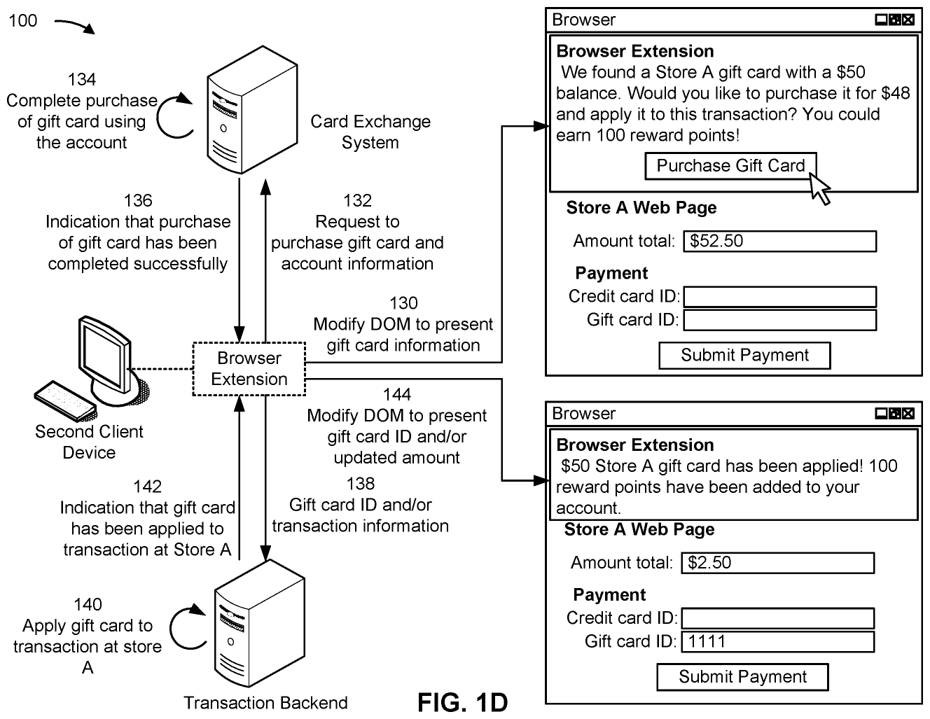

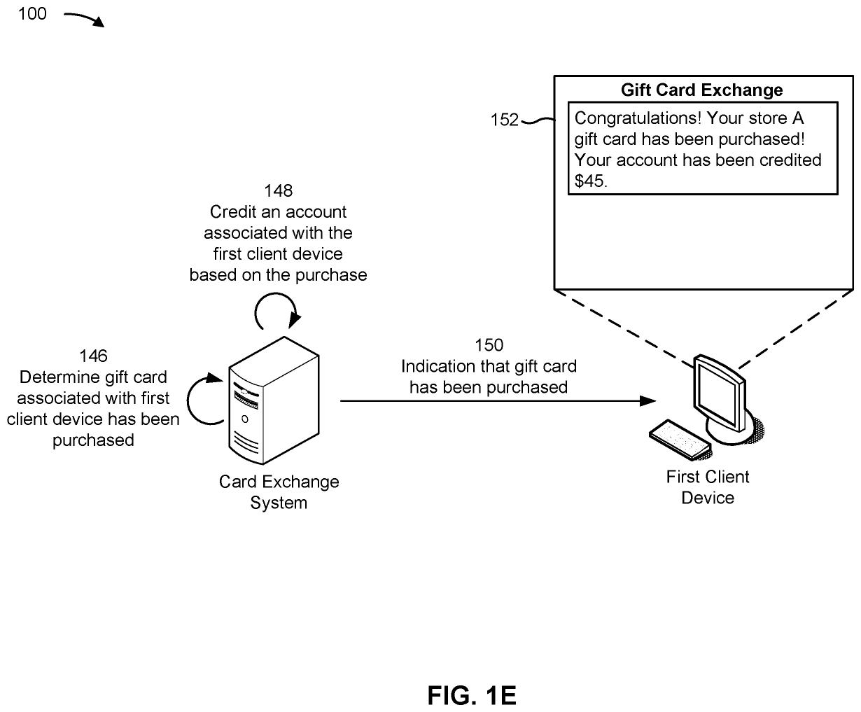

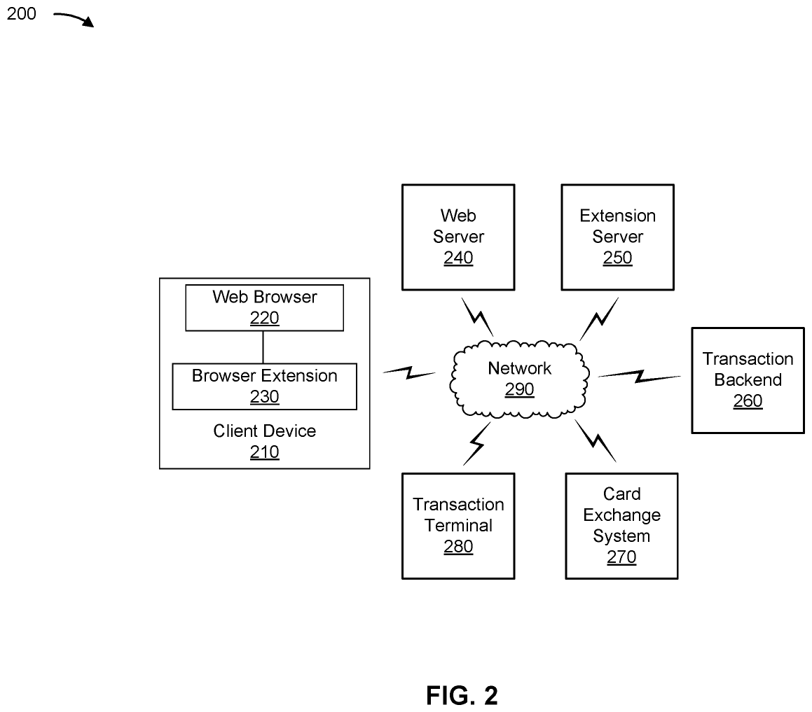

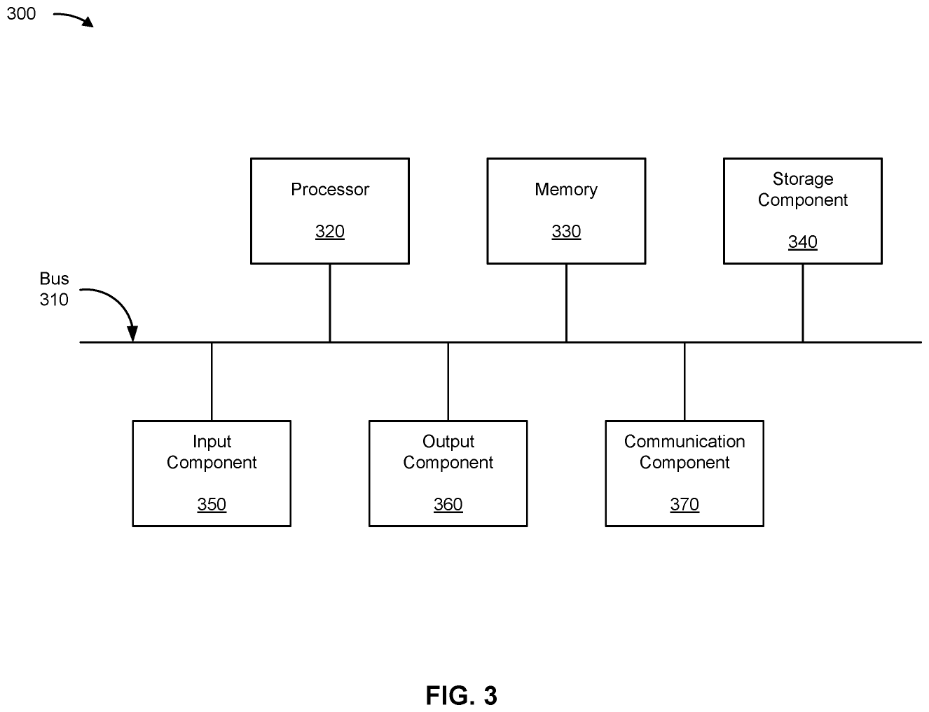

FIGS. 1A-1E are diagrams of an example 100 associated with modifying a user interface. As shown in FIGS. 1A-1E, example 100 includes a first client device, a second client device, a card exchange system, and a transaction backend. The first client device and/or the second client device may execute a web browser and a browser extension. These devices are described in more detail in connection with FIGS. 2 and 3.

As shown in FIG. 1A, and by reference number 102, a gift card owner (e.g., a user who is in possession of or owns a gift card) may access, via the first client device, a gift card exchange platform. The gift card exchange platform may be a web page or an application executing on the first client device. In some implementations, the gift card may not be associated with a physical card or physical medium. Therefore, as used herein, “gift card” may refer to stored value resources that can be used to complete transactions at one or more entities. For example, “gift card” may refer to an account balance, a reward point balance, convertible points, store credit, and/or other types of resources that are redeemable or otherwise usable at one or more entities for completing transactions. In some implementations, the gift card exchange platform may be included in, or may be associated with, a payment application executing on the first client device (e.g., a digital wallet application). The gift card exchange platform may display a user interface that enables the gift card owner to input gift card information. Gift card information may include a gift card identifier (e.g., a card number or a credential), a balance (e.g., an amount of a prepaid stored value of the gift card that is remaining), an entity associated with the gift card (e.g., a merchant or retailer), and/or expiration information (e.g., an expiration date or an expiration month and year), among other examples. In some implementations, a gift card may be associated with multiple entities or may be generally applicable (e.g., may be capable of being applied at any entity that accepts transactions from an institution associated with the gift card). A transaction may be referred to herein as an exchange, an electronic exchange, a transfer, a sale, a purchase, and/or other similar terms.

In some implementations, the gift card owner may wish to make a gift card (e.g., an unwanted gift card) available for purchase by another user. The gift card owner may input the gift card information associated with the unwanted gift card into the gift card exchange platform via the first client device. The gift card information may be manually input by the gift card owner or may be obtained by the first client device (e.g., by scanning the unwanted gift card using a camera of the first client device or by communicating with a radio frequency (RF) component, such as a near field communication (NFC) component, of the unwanted gift card). For example, as shown in FIG. 1A, gift card information for an unwanted gift card may indicate that a gift card identifier is “1111,” a balance is “$50.00,” and an entity associated with the unwanted gift card is “Store A.” As shown in FIG. 1A, the first client device may receive an input indicating that the gift card owner desires to make the unwanted gift card available on the gift card exchange platform. For example, the first client device may receive an input requesting an offer for the unwanted gift card.

As shown by reference number 104, based on receiving the input indicating that the gift card owner desires to make the unwanted gift card available, the first client device may transmit, to the card exchange system, an indication of the gift card information associated with the unwanted gift card. The card exchange system may generate an offer for the unwanted gift card based on the gift card information. In some implementations, rather than a monetary offer, the card exchange platform may generate an offer for reward points or credit that can be redeemed at multiple entities (e.g., multiple merchants or retailers). For example, the card exchange system may be associated with an institution that provides reward points or credit that can be redeemed at multiple entities. The card exchange system may generate an offer for reward points or credit to be applied to an account of the gift card owner associated with the institution.

For example, the card exchange system may generate an offer for the unwanted gift card based on the balance of the unwanted gift card. In some implementations, the offer may be equal to the balance of the unwanted gift card (e.g., $50.00). In some implementations, the offer may be less than the balance of the unwanted gift card (e.g., a nominal amount less than the balance of the unwanted gift card, such as $45 as shown in FIG. 1A). In some implementations, the offer may be a percentage or portion of the balance of the unwanted gift card (e.g., 98% of the balance of the unwanted gift card). In some implementations, the offer may be based on the entity associated with the unwanted gift card. For example, the card exchange system may generate a higher offer for a gift card having a balance and associated with a certain entity when compared to a different gift card having the same balance and associated with a different entity. For example, the card exchange system may generate a higher offer for gift cards associated with entities that are frequently visited or transacted with. The card exchange system may analyze historical transaction information or historical sales of gift cards by the card exchange system to identify one or more entities that are frequently visited or frequently transacted with. The card exchange system may generate a higher offer for gift cards associated with the one or more identified entities because the card exchange system may have a higher likelihood of selling the gift cards to purchasers (e.g., because the one or more entities are frequently visited with or frequently transacted with).

In some implementations, the gift card information may indicate an acceptable offer or a range of acceptable offers for the unwanted gift card. For example, the gift card owner may input the acceptable offer or the range of acceptable offers and the first client device may transmit an indication of the offer or the range of acceptable offers for the unwanted gift card to the card exchange system. For example, the gift card information may indicate that, for the unwanted gift card having a $50 balance, an acceptable offer is $45 or between $42 and $50. The card exchange system may determine an offer for the unwanted gift card based on the indicated acceptable offer or a range of acceptable offers for the unwanted gift card. In some implementations, the card exchange system may determine a cost (e.g., as described in more detail below) for the unwanted gift card based on the indicated acceptable offer or a range of acceptable offers for the unwanted gift card. For example, an initial cost may for the unwanted gift card may be based on a higher amount indicated in a range of acceptable offers. The card exchange system may modify a cost of the unwanted gift card based on an amount of time that the unwanted gift card has been made available to the card exchange system. For example, if the unwanted gift card has not been used or purchased (e.g., as explained in more detail below) for an amount of time, then the card exchange may decrease a cost of the unwanted gift card (e.g., resulting in a low payment to the gift card owner).

As shown by reference number 106, the card exchange system may transmit, to the first client device, an indication of the offer (or a range of offers) for the gift card. For example, the card exchange system may provide instructions to the first client device to provide the offer for display via the first client device (e.g., via a web page or application executing on the first client device associated with the gift card exchange platform). As shown in FIG. 1A, the first client device may provide an offer of $45 for display (e.g., via a user interface being displayed by the first client device) for the unwanted gift card input by the gift card owner. In some implementations, the provide a range of offers of $42 to $48 for display (e.g., via a user interface being displayed by the first client device) for the unwanted gift card input by the gift card owner (e.g., indicating that the gift card owner may receive between $42 and $48 for the unwanted gift card depending on a cost at which the gift card is sold, as described in more detail below). As shown by reference number 108, the gift card owner may accept the offer by providing an input to the user interface being displayed by the first client device. For example, the first client device may receive the input indicating an acceptance of the offer. The first client device may transmit, to the card exchange system, an indication that the offer for the unwanted gift card has been accepted.

In some implementations, upon receiving the indication that the offer for the unwanted gift card has been accepted, the card exchange system may cause an account associated with the gift card owner to be credited with the value (e.g., the monetary value) of the offer. In some implementations, the card exchange system may cause the account associated with the gift card owner to be credited with the value of the offer after the unwanted gift card has been purchased by another user, as described in more detail below.

In some implementations, after accepting the offer, the unwanted gift card may still be available for use by the gift card owner. For example, the indication that the offer for the unwanted gift card has been accepted may cause the unwanted gift card to be made available to other users, as described in more detail below, rather than initiating a transfer of ownership of the unwanted gift card. For example, until the unwanted gift card has been purchased by another user, the gift card owner may retain ownership of the unwanted gift card and may be enabled to use the unwanted gift card to complete transactions. In some implementations, the first client device may transmit, to the card exchange system and after transmitting the indication that the offer for the unwanted gift card has been accepted, an indication when the unwanted gift card has been used by the gift card owner. For example, the first client device may transmit, to the card exchange system, an updated balance of the unwanted gift card or an indication that the balance of the gift card is zero (e.g., indicating that the gift card has no value and should no longer be made available to other users). The first client device may identify the updated balance based on an input provided by the gift card owner or based on maintaining the unwanted gift card in the gift card platform or a payment application executing on the first client device.

As shown by reference number 110, after receiving the indication that the offer for the unwanted gift card has been accepted, the card exchange system may store the gift card information associated with the unwanted gift card in a data structure (e.g., a gift card database). The gift card database may include or identify gift card information for multiple (e.g., hundreds, thousands, or millions of) gift cards that are available for purchase (e.g., available gift cards that have been made available to the card exchange system in a similar manner as described above).

As shown by reference number 112, the gift card database may identify gift card information for available gift cards. The gift card information may include an entity (e.g., merchant) identifier, a gift card identifier, a balance, and/or expiration information (e.g., an expiration date or an expiration month and year), among other examples. In some implementations, an available gift card may be associated with multiple entity identifiers or an indication that the gift card can be applied at any entity (e.g., that accepts transactions from an institution associated with the gift card). For an available gift card that can be applied at any entity, the gift card database may identify the institution (e.g., bank or financial institution, such as VISA, Mastercard, and/or American Express) associated with the available gift card.

The card exchange system may determine or identify a cost for each available gift card. The cost may be an amount for which an available gift card is to be made available (e.g., an amount that a user must pay to purchase the available gift card). In some implementations, the cost for an available gift card may be based on the balance of the available gift card. For example, the cost may be equal to the available balance. In some implementations, the cost may be less than the available balance (e.g., to incentivize a user to purchase the available gift card). In some implementations, the cost may be based on the amount of the offer associated with the available gift card (e.g., accepted by the gift card owner as described above). For example, the cost may be equal to the amount of the offer associated with the available gift card.

In some implementations, the cost may be based on a portion or a percentage of a balance to be purchased by a user. For example, the cost may be 95% of the balance of the available gift card. If a user purchases the full balance of the gift card, the cost charged to the user may be 95% of the balance. However, if the user purchases a portion of the balance, the cost charged to the user may be 95% of the portion of the balance purchased by the user. For example, as described below, an available gift card may be offered to a user that has a balance greater than a transaction amount (e.g., the balance of the available gift card may be $50 and a transaction amount may be $25). Therefore, the card exchange system may provide an offer to the user to purchase $25 of the $50 balance for a cost of $23.75 (e.g., 95% of $25), as described in more detail below.

In some implementations, the cost may be greater than the amount of the offer associated with the available gift card (e.g., to enable an institution associated with the card exchange system to retain the difference as profit for providing the gift card exchange system). For example, for a gift card with a balance of $50, the offer for the gift card may be $45, as described above. The card exchange system may determine or identify that the cost of the gift card is $48 (e.g., enabling the institution associated with the card exchange system to retain $3 in profit when the gift card is purchased while still incentivizing a user to purchase the gift card for less than the balance of the gift card). The card exchange system may store, in the gift card database, a cost associated with each available gift card included in the gift card database.

The card exchange system may monitor and/or update gift card information identified in the gift card database. For example, as described above, the card exchange system may receive an indication of, or identify, an updated balance of an available gift card (e.g., based on a gift card owner using the available gift card to complete a transaction). The card exchange system may identify an entry associated with the available gift card in the gift card database and may update the balance identified in the entry. In some implementations, the card exchange system may monitor (e.g., periodically) a balance of each available gift card by communicating with a platform of the institution associated with a (or each) available gift card identified in the gift card database. For example, the card exchange system may communicate with the platform to request and/or receive an indication of a current balance of the available gift card. If an updated balance indicates that there is no balance left (e.g., a $0 balance) associated with an available gift card, then the card exchange system may remove the available gift card from the gift card database (e.g., may remove or delete an entry associated with the available gift card from the gift card database). Additionally, or alternatively, the card exchange system may monitor (e.g., periodically, such as once a month or once a week) expiration information indicated in the gift card database to identify any expired available gift cards. The card exchange system may remove expired available gift cards from the gift card database (e.g., may remove or delete an entry associated with the expired available gift cards from the gift card database). In this way, the card exchange system may ensure that gift card information indicated in the gift card database is accurate and current. Moreover, this may conserve memory resources associated with storing the gift card database by removing gift card information for expired available gift cards and/or gift cards with no remaining balance. Additionally, the real-time nature of the exchange (e.g., based on a current balance of a gift card) may reduce a likelihood of fraud. For example, by storing the remaining balance of a gift card, identifying the gift card as relevant to a transaction, and simultaneously completing transactions using the gift card (e.g., as described in more detail below) a likelihood of fraud is reduced due to the real-time nature of the transaction.

As shown in FIG. 1B, a user may interact with the second client device, that executes a web browser and a browser extension, to initiate a transaction with an entity. For example, as shown by reference number 114, the user may navigate to a web page associated with the entity and select one or more products or services to purchase. The web page may be a point of sale page (e.g., a checkout page or another web page associated with a point of sale). For example, the web page may indicate transaction information (e.g., products and/or services to be purchased and/or a transaction amount) and/or one or more fields for the user to input identifiers for a transaction card (e.g., a credit card or a debit card) or a gift card. In some implementations, the browser extension may request access to web page information for the purposes of identifying relevant gift cards. The user may provide an input to the second client device granting the browser extension access to web page information.

As shown by reference number 116, the browser extension (or the second client device) may detect that the web page is associated with an entity and a transaction (e.g., the browser extension may detect that the web page is a point of sale page or a checkout page). For example, the browser extension may analyze information associated with the web page to identify the entity and/or identify that the web page is a point of sale page. In some implementations, the browser extension may detect that the web page accepts gift cards as a form of payment (e.g., based on detecting a field in which a gift card identifier or other card identifier can be input to complete the transaction).

As shown by reference number 118, based on detecting that the web page is associated with an entity and a transaction (e.g., based on detecting that the web page is a point of sale page), the browser extension may cause the second client device to transmit, to the card exchange system, point of sale information. The point of sale information may include an indication or identifier of the entity associated with the transaction and/or transaction information (e.g., a transaction amount, one or more products or services associated with the transaction, and/or a transaction date), among other examples. For example, the browser extension may extract or identify the point of sale information based on the information being presented for display on the web page (e.g., via the second client device). The browser extension (and/or the second client device) may identify this point of sale information from the web page, a document used to generate the web page (e.g., a document object model (DOM) and/or a hypertext markup language (HTML) document), and/or a uniform resource locator (URL) of the web page, such as by parsing the web page, DOM, or URL for keywords, by extracting information from a particular field, information element, or portion of the web page, DOM, or URL, and/or identifying the point of sale information based on a URL of the web page (e.g., by looking up a merchant, product, or other point of sale information stored in a data structure in association with the URL), among other examples. In some implementations, the browser extension may cause the second client device to transmit, to the card exchange system, point of sale information based on detecting that the web page accepts gift cards as a form of payment. As shown in FIG. 1B, the point of sale information may indicate that the transaction is associated with an entity of “Store A” and a transaction amount of “$52.50.”

Although the example above (and other examples described herein) are described with respect to a web browser and a browser extension executing on the second client device, other examples are also possible. For example, an application may be executing on the second client device. The application may display a point of sale page in a similar manner as the web page described above. The second client device may detect and/or transmit point of sale information displayed by the application in a similar manner as described above. In some implementations, the user may be conducting a transaction in a physical location associated with the entity (e.g., at a transaction terminal). The second client device may be a mobile device or a user device that receives information similar to (or the same as) the point of sale information described above (e.g., from the transaction terminal, from a payment application executing on the second client device, or from another device, such as a transaction device or transaction card). The second client device may detect that a transaction has been initiated (e.g., at the transaction terminal). The second client device may transmit, to the card exchange system, the information similar to (or the same as) the point of sale information to enable the card exchange system to identify and/or provide relevant gift card information to be displayed on the second client device, as described in more detail below.

In some implementations, the card exchange system may identify point of sale information (e.g., an entity) based on location information of the second client device. For example, as described above, user may be conducting a transaction in a physical location associated with the entity and the second client device may be a mobile device. The card exchange system may obtain or identify location information (e.g., coordinates) of the second client device. The card exchange system may determine that the second client device is located in or near a physical location associated with the entity based on the location information. The card exchange system may identify relevant gift cards associated with the entity to be provided to the second client device (e.g., in a similar manner as described elsewhere herein) based on determining that the second client device is located in or near a physical location associated with the entity.

As shown in FIG. 1C, the card exchange system may receive, from the browser extension (and/or the second client device) the point of sale information. As shown by reference number 120, the card exchange system may identify, in the gift card database, one or more relevant gift cards based on the point of sale information that is to be provided to the second client device (e.g., to be offered for purchase to the user). A relevant gift card may be a gift card that can be applied to a transaction at the entity indicated by the point of sale information and/or a gift card that has a similar account balance as a transaction amount indicated by the point of sale information (e.g., and is active or not expired).

The card exchange system may search, sort, and/or parse the gift card database to identify available gift cards associated with, or that can be used at, the entity indicated by the point of sale information. For example, as shown by reference number 122, if the point of sale information indicates that the transaction is associated with an entity of “Store A,” then the card exchange system may identify available gift cards in the gift card database associated with Store A (e.g., associated with an identifier indicating Store A). In some implementations, in addition to identifying available gift cards in the gift card database associated with Store A, the card exchange system may identify available gift cards in the gift card database that can be used at multiple entities (including Store A) or at any entity.

From the set of available gift cards associated with the entity indicated by the point of sale information (or capable of being applied at any entity), the card exchange system may identify one or more relevant cards based on the transaction amount indicated by the point of sale information. In some implementations, the card exchange system may identify available gift cards, from the set of available gift cards associated with the entity (e.g., Store A or capable of being applied at any entity), that have a balance equal to or less than the transaction amount indicated by the point of sale information (e.g., to enable the user to use the entire balance of the gift card at the transaction so that the user is not left with a gift card having a balance). In some implementations, the card exchange system may identify available gift cards, from the set of available gift cards associated with the entity (e.g., Store A), that have a balance equal to or greater than the transaction amount indicated by the point of sale information (e.g., to enable the user to complete the transaction using only the gift card). In the example where the card exchange system identifies available gift cards that have a balance equal to or greater than the transaction amount, the card exchange system may retain the gift card in the gift card database with an updated balance (e.g., after the gift card is applied to the transaction) so that the user is not left with a gift card having a balance.

If the card exchange system identifies multiple relevant gift cards (e.g., from the set of available gift cards associated with the entity based on the transaction amount), then the card exchange system may select a relevant gift card, from the multiple relevant gift cards, based on which gift card, in the multiple relevant gift cards, has a balance that is closest to the transaction amount indicated by the point of sale information. In some implementations, if multiple relevant gift cards have the same balance and have the balance closest to the transaction amount, then the card exchange system may select a relevant gift card based on an amount of time that each gift card has been stored in the gift card database. For example, the card exchange system may select the gift card that has been stored in the gift card database for the most amount of time (e.g., of the multiple relevant gift cards). In other words, if the card exchange system identifies multiple relevant gift cards based on the point of sale information, then the card exchange system may select the gift card that was first added to the gift card database. In some implementations, the card exchange system may select a relevant gift card based on an expiration date. For example, if multiple relevant gift cards have the same balance and have the balance closest to the transaction amount, then the card exchange system may select a relevant gift card based on which gift card, of the multiple relevant gift cards, is to expire first. The card exchange system may select the gift card, from the multiple relevant gift cards, that expires first.

For example, as shown by reference numbers 124 and 126, the card exchange system may identify two available gift cards (e.g., the gift card with an identifier of “1111” as shown by reference number 124 and the gift card with an identifier of “1357” as shown by reference number 126) that are both associated with Store A and both have a closest account balance (e.g., $50) to the transaction amount (e.g., $52.50). The card exchange system may identify that the “1111” gift card was added to the gift card database before the “1357” gift card. Therefore, the card exchange system may select the “1111” gift card to be provided to the second client device (e.g., to be offered for purchase to the user). In some implementations, the card exchange system may identify multiple relevant gift cards to be provided to the second client device (e.g., rather than the single relevant gift card in the example described above). For example, using the example above, the card exchange system may identify the “1111” gift card and the “1357” gift card to be provided to the second client device (e.g., to be offered for purchase to the user). In some implementations, the card exchange system may identify relevant gift cards that have balances that are within a range (e.g., that is based on the transaction amount) to enable the user to select from multiple relevant gift cards based on the needs of the user (e.g., the user may desire to have a gift card with a balance left after completing the present transaction).

In some implementations, the card exchange system may identify a relevant gift card to be provided to the second client device based on savings amounts associated with the gift cards. The savings may refer to a difference between a balance of the relevant gift card and the cost of the relevant gift card (e.g., if the balance of the gift card is $50 and a cost of the gift card is $48, then the savings may be $2). The card exchange system may identify a set of gift cards that are capable of being used or applied at the entity associated with the transaction. The card exchange system may identify one or more gift cards, from the set of gift cards, that have a greatest savings amount. This may enable the card exchange system to offer a relevant gift card to the user of the second client device that provides the user with the greatest savings. If the card exchange system identifies multiple gift cards with a greatest savings amount, then the card exchange system may select a relevant gift card (from the multiple gift cards with the greatest savings amount) based on an amount of time that each gift card has been stored in the gift card database and/or based on expiration information of the multiple gift cards (e.g., in a similar manner as described above).

In some implementations, the card exchange system may identify a relevant gift card to be provided to the second client device based on historical transaction information (e.g., in addition to or instead of the point of sale information). For example, the card exchange system may analyze historical transaction information associated with the user (e.g., information indicating past transactions completed by the user). The card exchange system may identify one or more entities with which the user frequently and/or has recently completed transactions. Similarly, the card exchange system may identify a category of transactions (e.g., building supplies, video games, clothes/fashion, groceries, and/or a type of restaurant) with which the user frequently and/or has recently completed transactions associated. The card exchange system may identify one or more relevant gift cards based on the identified entities and/or the identified shopping categories. For example, if the historical transaction information indicates that the user frequently shops at Merchant B, then the card exchange system may identify a gift card associated with Merchant B as a relevant gift card to be provided to the second client device (e.g., to be offered for purchase to the user). If the historical transaction information indicates that the user frequently shops at building supply stores and Store C is categorized as a building supplies store, then the card exchange system may identify a gift card associated with Store C as a relevant gift card to be provided to the second client device (e.g., to be offered for purchase to the user). The relevant gift card can be applied to a current transaction (e.g., as described in more detail below). In some implementations, the relevant gift card may be provided by the card exchange system to be used for future transactions. For example, because the card exchange system has identified the relevant gift card based on the historical transaction information, a likelihood that the relevant gift card will be used by the user for future transactions is increased (e.g., thereby reducing a likelihood that the user will forget to use the gift card).

As shown by reference number 128, the card exchange system may transmit, to the browser extension (and/or the second client device) the gift card purchase information for the identified relevant gift card (e.g., as described above). For example, the gift card purchase information may include an identifier of the relevant gift card, a balance of the relevant gift card, a cost of the relevant gift card, and/or incentive information, among other examples. The incentive information may include a benefit or reward to be applied to an account associated with the user if the user purchases the relevant gift card. For example, the incentive information may indicate a number of reward points, an amount of a cash back award, and/or a discount to be applied to the transaction or future transaction, among other examples.

As shown in FIG. 1D, the browser extension (and/or the second client device) may receive the gift card purchase information for the identified relevant gift card. As shown by reference number 130, the second client device may modify a document used to generate the web page (e.g., a DOM) by inserting code into the document that is based on presentation information associated with the gift card purchase information for the identified relevant gift card received from the card exchange. The presentation information may include the balance of the relevant gift card, the cost of the relevant gift card, and/or the incentive information. In some implementations, the presentation information may include information associated with resources of the relevant gift card. For example, the presentation information may not indicate the gift card information and instead may indicate that the browser extension has identified a potential savings for the transaction. The savings may refer to a difference between a balance of the relevant gift card and the cost of the relevant gift card (e.g., if the balance of the gift card is $50 and a cost of the gift card is $48, then the savings may be $2). Additionally, or alternatively, the savings may refer to the incentive information. The code may include HTML code, cascading style sheet (CSS) code, a script, or any other code capable of causing the web page to present information. After the code is inserted, the second client device may provide the web page for presentation and/or may present the web page for display. Insertion of the code may cause the web page to be presented differently than if the web page were presented without the code.

For example, as shown in FIG. 1D, the code may cause the web page to be presented with an indication of the relevant gift card, the balance of the relevant gift card, the cost of the relevant gift card, and a request to purchase the relevant gift card. For presentation information identifying a balance of $50, a cost of $48, and incentive information of 100 Reward Points, the code may cause a message of “We found a Store A gift card with a $50 balance. Would you like to purchase it for $48 and apply it to this transaction? You could earn 100 reward points!” to be displayed by the second client device (e.g., on the web page). As another example, the code may cause a message of “We found a $2 savings for this transaction. Would you like us to apply the savings to this transaction?” to be displayed by the second client device. For example, the presentation information may not indicate that the gift card is being purchased, but rather that a savings can be applied to this transaction associated with the gift card, as described above. As shown in FIG. 1D, the presentation information does not include the gift card identifier (e.g., the credential that would enable the user to complete a transaction using the gift card).

The user may provide an input to the second client device (e.g., via the web page or user interface displayed by the second client device) indicating a desire to purchase the relevant gift card. In some implementations, the browser extension (and/or the second client device) may not require an input and may proceed with applying a balance of the gift card to the transaction automatically (e.g., based on an account (e.g., associated with the browser extension and/or card exchange system) of the user of the second client device being registered for a service provided by the card exchange system). As shown by reference number 132, the browser extension (and/or the second client device) may transmit, to the card exchange system, a request to purchase the relevant gift card and/or account information to be used to complete the purchase (e.g., an account identifier). The account information may be identified by the second client device based on stored account information (e.g., in the second client device or in another device, such as a server device). For example, the user may have previously input the account information and/or granted access to the account information to the browser extension and/or the second client device. In some implementations, based on receiving the input indicating the desire to purchase the relevant gift card, the browser extension (and/or the second client device) may determine whether the browser extension (and/or the second client device) can identify the account information associated with the user. If the browser extension (and/or the second client device) determines that there is no stored account information associated with the user, then the browser extension (and/or the second client device) may request that the user input account information to the second client device (e.g., via the web page or user interface).

In some implementations, the second client device may cause a notification or an indication of the relevant gift card to be displayed on the second client device or by an application executing on the second client device. For example, if the transaction is initiated in a physical location (e.g., at a transaction terminal), then the second client device may provide a notification to be displayed on a user interface of the second client device indicating the presentation information described above. The notification may enable the user to provide an input, via the user interface, indicating a desire to purchase the relevant gift card, in a similar manner as described above.

As shown by reference number 134, the card exchange system may complete the purchase of the relevant gift card using resources of the account identified by the account information (e.g., the user account). For example, the card exchange system may charge the account for the cost (e.g., $48 as shown in FIG. 1D) of the relevant gift card. The card exchange system may communicate with a backend system of an institution associated with the user account to complete the purchase of the relevant gift card using resources of the user account. In some implementations, the card exchange system may cause resources of the account identified by the account information to be transferred to an account of the gift card owner associated with the relevant gift card (e.g., based on the amount of the offer for the relevant gift card, as described above in connection with FIG. 1A). For example, when the relevant gift card is purchased, the card exchange system may cause the amount of the offer for the relevant gift card (e.g., $45 as described above in connection with FIG. 1A) to be transferred from the user account to the gift card owner account.

In some implementations, the card exchange system may redeem points (e.g., reward points) of an account of the user to purchase or otherwise obtain the relevant gift card (e.g., rather than charging an account, such as a credit account or a debit account, of the user). For example, an account of the user (e.g., associated with the browser extension and/or an entity associated with the browser extension) may offer reward points for using the browser extension and/or for transactions completed via the browser extension. The card exchange system may redeem reward points associated with the account of the user to obtain a relevant gift (e.g., to complete at least a portion the transaction) as described elsewhere herein.

As shown by reference number 136, in some implementations, the card exchange system may transmit, to the browser extension (and/or the second client device) an indication that the purchase of the relevant gift card has been completed successfully. In some implementations, based on receiving the indication that the purchase of the relevant gift card has been completed successfully, the browser extension (and/or the second client device) may automatically (e.g., without user input) cause the transaction (or a portion of the transaction) to be completed using resources (e.g., the remaining balance, or a balance equal to the transaction amount, of the prepaid stored value) of the relevant gift card. For example, as shown by reference number 138, the browser extension (and/or the second client device) may transmit, to a transaction backend, an indication of the gift card identifier (e.g., a card number, an account number, an account identifier, and/or a token associated with the gift card) and/or transaction information associated with the transaction (e.g., an identifier of the entity associated with the transaction, a transaction date and/or time, and/or a transaction amount).

As shown by reference number 140, the transaction backend may use resources of the relevant gift card to complete the transaction (or a portion of the transaction). For example, the transaction backend may apply the resources of the relevant gift card (e.g., the balance) to the transaction amount. In the example shown in FIG. 1D, the balance of the relevant gift card may be $50 and the transaction amount may be $52.50. The transaction backend may apply the $50 balance of the relevant gift card to the $52.50 transaction amount, resulting in a remaining transaction amount of $2.50.

As shown by reference number 142, the transaction backend may transmit, to the browser extension (and/or the second client device) an indication that the relevant gift card has been successfully applied to the transaction. In some implementations, the transaction backend may indicate that the entire transaction has been successfully completed (e.g., if the balance of the relevant gift card is equal to or greater than the transaction amount). In some implementations, the transaction backend may indicate a remaining transaction amount (e.g., if the balance of the relevant gift card is less than the transaction amount).

In some implementations, the gift card may not be explicitly purchased by the user of the second client device. For example, rather than transmitting a request to purchase the gift card to the card exchange system, the browser extension (and/or the second client device) may request access to the resources associated with the gift card for the purpose of completing the transaction. The card exchange system may grant the request if the gift card is available and may transmit, to the browser extension (and/or the second client device) or the transaction backend, an indication of the gift card identifier (e.g., a card number, an account number, an account identifier, and/or a token associated with the gift card). The transaction backend may apply a balance of the gift card to the transaction amount or may store the gift card identifier for the purposes of applying the balance of the gift card when the transaction is completed by the user (e.g., as described below).

In some implementations, the card exchange system may update the gift card database based on the relevant gift being successfully applied to the transaction. For example, if an entire balance of the relevant gift card is used when the relevant gift card is applied to the transaction, then the card exchange system may remove gift card information associated with the relevant gift card from the gift card database. If only a portion of the balance of the relevant gift card is used when the relevant gift card is applied to the transaction, then the card exchange system may update the balance of the relevant gift card in the gift card database.

As shown by reference number 144, the browser extension (and/or the second client device) may cause the relevant gift card identifier and/or the updated transaction amount to be provided for display via the user interface and the second client device (e.g., via the web page). For example, the second client device may modify a document used to generate the web page (e.g., a DOM) by inserting code into the document that is based on the relevant gift card identifier and/or the updated transaction amount. For example, the code may cause the updated transaction amount (e.g., $2.50) to be displayed in a transaction amount field of the web page. In some implementations, the code may cause the relevant gift card identifier (e.g., “1111”) to be inserted in a gift card identifier field of the web page. In some implementations, the code may cause a message to be displayed indicating that the gift card was successfully purchased and applied to the present transaction and/or indicating incentive information. For example, the message may be “$50 Store A gift card has been applied! 100 reward points have been added to your account.”

In some implementations, the second client device may modify a document used to generate the web page (e.g., a DOM) by inserting code into the document that is based on the savings associated with the gift card, as described above. For example, if the savings is $2 (e.g., based on the gift card having a balance of $50 and a cost of $48), then the code may cause an updated transaction amount (e.g., $50.50) that is based on the savings to be displayed in a transaction amount field of the web page. The code may cause a message to be displayed indicating that the savings has been applied to the transaction (e.g., “$2 savings applied to this transaction!”).

In some implementations, rather than automatically complete the transaction (or a portion of the transaction) using the relevant gift card as described above, the second client device may cause the relevant gift card identifier to be displayed or provided to enable the user to initiate the transaction using the relevant gift card. For example, the second client device may cause the relevant gift card identifier to be inserted to the gift card identifier field of the web page. In some implementations, where the transaction is initiated at a physical location, the second client device may cause the gift card identifier to be displayed by a user interface of the second client device (e.g., enabling the user or the second client device to provide the relevant gift card identifier to a transaction terminal). In some implementations, the second client device may cause the gift card identifier to be provided to a payment application executing on the second client device or a transaction device. Based on the second client device providing the relevant gift card identifier, the user may use the payment application executing on the second client device or the transaction device to complete or continue with the transaction using the relevant gift card identifier (e.g., at a transaction terminal or on another application executing on the second client device).

As shown in FIG. 1D, the user may proceed with completing the transaction based on the updated transaction amount (e.g., $2.50). For example, the user may input an identifier of a transaction card (e.g., in the credit card identifier field) into the web page via the second client device. In some implementations, the user may present a transaction device or a transaction card to a transaction terminal to complete the transaction. The second client device (or a transaction terminal) may communicate with the transaction backend to complete the transaction using resources of an account associated with the transaction card. In this way, the user may purchase a gift card for a nominal discount (e.g., $48 cost for a gift card with a $50 balance) and/or receive incentives (e.g., reward points) for purchasing the gift card. The user may be enabled to immediately use the gift card since the gift card is relevant to a current transaction (e.g., can be applied to the current transaction) and is presented at a point of sale. This ensures that the gift card will be used and increases the likelihood that the gift card will be purchased by a user who will actually use the gift card.

In some implementations, the user may proceed with completing the transaction based on the updated transaction amount that is based on the savings associated with the gift card (e.g., $50.50). For example, the user may input an identifier of a transaction card (e.g., in the credit card identifier field) into the web page via the second client device. The second client device may communicate with the transaction backend to complete the transaction. For example, the transaction backend may use resources of the account based on the updated transaction amount that is based on the savings associated with the gift card (e.g., $50.50). The transaction backend may use the resources of the account to complete a purchase of the gift card for the cost of the gift card (e.g., for $48) and may use the remainder of the resources (e.g., $2.50) to complete the transaction. For example, the transaction backend may communicate with the card exchange system to purchase the gift card for the cost of the gift card (e.g., $48) using the resources of the account of the user. The transaction backend may apply the balance of the gift card (e.g., $50) to the transaction amount (e.g., resulting in a remaining transaction amount of $2.50). The transaction backend may complete the transaction by applying the remaining resources provided by the account of the user (e.g., $2.50 after removing the $48 cost of the gift card) to the remaining transaction amount (e.g., $2.50 after applying the $50 balance of the gift card). In this way, the account of the user may be only used for a single transaction (e.g., the $50.50 transaction after the savings associated with the gift card is applied by the browser extension as described above). This may conserve resources that would have otherwise been used to complete multiple transactions using the account of the user.

As shown in FIG. 1E, and by reference number 146, the card exchange system determines that a gift card associated with the first client device (e.g., associated with a gift card owner) has been purchased. For example, the card exchange system may track or store an identifier of the gift card owner (or of an account of the gift card owner) for each gift card stored in the gift card database. When a gift card is purchased by a user or by the transaction backend completing the transaction using the balance of the gift card (e.g., as described above), the card exchange system may identify the gift card owner (or the gift card owner account) associated with the gift card.

As shown by reference number 148, the card exchange system may credit the account associated with the relevant gift card owner (e.g., an account associated with the first client device) based on the purchase of the gift card, as described above. For example, the card exchange system may credit the account associated with the gift card owner based on an amount of the offer associated with the relevant gift card. In some implementations, the card exchange system may credit the account associated with the gift card owner at the time of (or shortly after) the purchase of the gift card by the user. In some implementations, as described above, the card exchange system may credit the account associated with the gift card owner at the time of (or shortly after) the indication that the offer for the gift card is accepted. In some implementations, as described above, the card exchange system may transfer resources from a user account (e.g., an account of a user who purchases the gift card) or resources indicated by the transaction backend to the gift card owner account.

As shown by reference number 150, the card exchange system may transmit, to the first client device, an indication that the gift card has been purchased and/or an indication that an account associated with the gift card owner has been credited. For example, the card exchange system may cause a message to be transmitted to the first client device or may cause an application executing on the first client device to display a notification indicating that the gift card has been purchased and/or indicating that an account associated with the gift card owner has been credited. As shown by reference number 152, the first client device may display the indication that the gift card has been purchased and/or an indication that an account associated with the gift card owner has been credited. For example, the first client device may display a message of “Congratulations! Your store A gift card has been purchased! Your account has been credited $45.” In this way, the gift card owner may be notified that the gift card has been purchased and may not attempt to use the gift card to complete future transactions.

As indicated above, FIGS. 1A-1E are provided as an example. Other examples may differ from what is described with regard to FIGS. 1A-1E.

FIG. 2 is a diagram of an example environment 200 in which systems and/or methods described herein may be implemented. As shown in FIG. 2, environment 200 may include a client device 210 (e.g., which may execute a web browser 220 and a browser extension 230), a web server 240, an extension server 250, a transaction backend 260, a card exchange system 270, a transaction terminal 280, and a network 290. Devices of environment 200 may interconnect via wired connections, wireless connections, or a combination of wired and wireless connections.

Client device 210 includes a device that supports web browsing. For example, client device 210 may include a computer (e.g., a desktop computer, a laptop computer, a tablet computer, a handheld computer, and/or the like), a mobile phone (e.g., a smart phone and/or the like), a television (e.g., a smart television), an interactive display screen, and/or a similar type of device. Client device 210 may host a web browser 220 and/or a browser extension 230 installed on and/or executing on the client device 210.

Web browser 220 includes an application, executing on client device 210, that supports web browsing. For example, web browser 220 may be used to access information on the World Wide Web, such as web pages, images, videos, and/or other web resources. Web browser 220 may access such web resources using a uniform resource identifier (URI), such as a uniform resource locator (URL), a uniform resource name (URN), and/or the like. Web browser 220 may enable client device 210 to retrieve and present, for display, content of a web page.

Browser extension 230 includes an application, executing on client device 210, capable of extending or enhancing functionality of web browser 220. For example, browser extension 230 may be a plug-in application for web browser 220. Browser extension 230 may be capable of executing one or more scripts (e.g., code, which may be written in a scripting language, such as JavaScript and/or the like) to perform an operation in association with the web browser 220.

Web server 240 includes a device capable of serving web content (e.g., web documents, HTML documents, web resources, images, style sheets, scripts, text, and/or the like). For example, web server 240 may include a server and/or computing resources of a server, which may be included in a data center, a cloud computing environment, and/or the like. Web server 240 may process incoming network requests (e.g., from client device 210) using hypertext transfer protocol (HTTP) and/or another protocol. Web server 240 may store, process, and/or deliver web pages to client device 210. In some implementations, communication between web server 240 and client device 210 may take place using HTTP.

Extension server 250 includes a device capable of communicating with client device 210 to support operations of browser extension 230. For example, extension server 250 may store and/or process information for use by browser extension 230. As an example, extension server 250 may store a list of domains applicable to a script to be executed by browser extension 230. In some implementations, client device 210 may obtain the list (e.g., periodically, based on a trigger, and/or the like), and may store a cached list locally on client device 210 for use by browser extension 230.

The transaction backend 260 includes one or more devices capable of processing, authorizing, and/or facilitating a transaction. For example, the transaction backend 260 may include one or more servers and/or computing hardware (e.g., in a cloud computing environment or separate from a cloud computing environment) configured to receive and/or store information associated with processing an electronic transaction. The transaction backend 260 may process a transaction, such as to approve (e.g., permit, authorize, or the like) or decline (e.g., reject, deny, or the like) the transaction and/or to complete the transaction if the transaction is approved. The transaction backend 260 may process the transaction based on information received from a transaction terminal, such as transaction data (e.g., information that identifies a transaction amount, a merchant, a time of a transaction, a location of the transaction, or the like), account information communicated to the transaction terminal by a transaction device (e.g., a transaction card, a mobile device executing a payment application, or the like) and/or information stored by the transaction backend 260 (e.g., for fraud detection). The transaction backend 260 may be associated with a financial institution (e.g., a bank, a lender, a credit card company, or a credit union) and/or may be associated with a transaction card association that authorizes a transaction and/or facilitates a transfer of funds. For example, the transaction backend 260 may be associated with an issuing bank associated with the transaction device, an acquiring bank (or merchant bank) associated with the merchant and/or the transaction terminal, and/or a transaction card association (e.g., VISA® or MASTERCARD®) associated with the transaction device. Based on receiving information associated with the transaction device from the transaction terminal, one or more devices of the transaction backend 260 may communicate to authorize a transaction and/or to transfer funds from an account associated with the transaction device to an account of an entity (e.g., a merchant) associated with the transaction terminal 280.

The card exchange system 270 includes one or more devices capable of receiving, generating, storing, processing, providing, and/or routing information associated with receiving, storing, and/or providing gift cards to be offered at relevant times, as described elsewhere herein. The card exchange system 270 may include a communication device and/or a computing device. For example, the card exchange system 270 may include a server, such as an application server, a client server, a web server, a database server, a host server, a proxy server, a virtual server (e.g., executing on computing hardware), or a server in a cloud computing system. In some implementations, the card exchange system 270 includes computing hardware used in a cloud computing environment.

The transaction terminal 280 includes one or more devices capable of facilitating an electronic transaction. For example, the transaction terminal 280 may include a point-of-sale (PoS) terminal, a payment terminal (e.g., a credit card terminal, a contactless payment terminal, a mobile credit card reader, or a chip reader), and/or an automated teller machine (ATM). The transaction terminal 280 may include one or more input components and/or one or more output components to facilitate obtaining data (e.g., account information) from a transaction device (e.g., a transaction card, a mobile device executing a payment application, or the like) and/or to facilitate interaction with and/or authorization from an owner or accountholder of the transaction device. Example input components of the transaction terminal 280 include a number keypad, a touchscreen, a magnetic stripe reader, a chip reader, and/or a radio frequency (RF) signal reader (e.g., a near-field communication (NFC) reader). Example output devices of transaction terminal 280 include a display and/or a speaker.

Network 290 includes one or more wired and/or wireless networks. For example, network 290 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to client device 210, web server 240, extension server 250, transaction backend 260, card exchange system 270, and/or transaction terminal 280. In some implementations, client device 210, web server 240, extension server 250, transaction backend 260, card exchange system 270, and/or transaction terminal 280 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

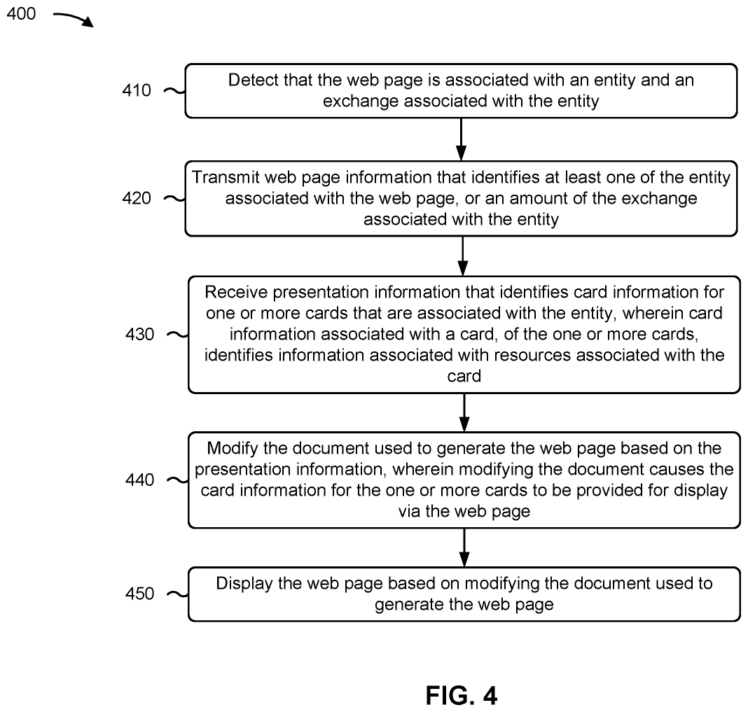

FIG. 4 is a flowchart of an example process 400 associated with modifying a user interface. In some implementations, one or more process blocks of FIG. 4 may be performed by a device (e.g., client device 210 and/or browser extension 230 executing on client device 210). In some implementations, one or more process blocks of FIG. 4 may be performed by another device or a group of devices separate from or including the device, such as web browser 220, web server 240, extension server 250, transaction backend 260, card exchange system 270, and/or transaction terminal 280. Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include detecting that the web page is associated with an entity and an exchange associated with the entity (block 410). As further shown in FIG. 4, process 400 may include transmitting, to a server, web page information that identifies at least one of: the entity associated with the web page, or an amount of the exchange associated with the entity (block 420). As further shown in FIG. 4, process 400 may include receiving, from the server, presentation information that identifies card information for one or more cards that are associated with the entity (block 430). In some implementations, card information associated with a card, of the one or more cards, identifies information associated with resources associated with the card. As further shown in FIG. 4, process 400 may include modifying the document used to generate the web page based on the presentation information (block 440). In some implementations, modifying the document causes the card information for the one or more cards to be provided for display via the web page. As further shown in FIG. 4, process 400 may include displaying the web page based on modifying the document used to generate the web page (block 450).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A non-transitory computer-readable medium storing a set of instructions for modifying a document object model of a user interface to be provided for presentation that makes resources of a card associated with an entity available at a relevant time, the set of instructions comprising:
one or more instructions that, when executed by one or more processors of a device, cause the device to:
detect that the user interface, to be provided for presentation by the device, is to display a checkout page associated with the entity;
identify exchange information associated with a first exchange indicated by the checkout page, the exchange information including an amount of the first exchange;
transmit, to a server device, user interface information that indicates the entity and the exchange information;
receive, from the server device, presentation information that indicates card information for the card associated with the entity based on transmitting the user interface information,
wherein the card information indicates information associated with the resources of the card;
modify the document object model of the user interface based on the presentation information to cause an indication of the card information to be provided for presentation via the user interface; and
provide the user interface for presentation by the device based on modifying the document object model.

2. The non-transitory computer-readable medium of claim 1, wherein the one or more instructions, when executed by the one or more processors, further cause the device to:
receive, via the user interface, a request to initiate a second exchange for the card, wherein the second exchange is for an exchange amount associated with the card;
transmit, to the server device, card exchange information that indicates the card information and an account of a user associated with the device;
receive, from the server device, a credential associated with the card that can be used to initiate an exchange using the card, wherein the card is enabled to complete exchanges for amounts up to and including an actual amount associated with the card; and
provide the user interface for presentation by the device indicating the credential associated with the card.

3. The non-transitory computer-readable medium of claim 2, wherein the one or more instructions, that cause the device to provide the user interface for presentation by the device indicating the credential associated with the card, cause the device to:
insert the credential associated with the card into a field of the user interface that is associated with credentials to be used for completing the first exchange.

4. The non-transitory computer-readable medium of claim 1, wherein an actual amount associated with the card is equal to or greater than an exchange amount associated with the card.

5. The non-transitory computer-readable medium of claim 1, wherein the presentation information indicates incentive information that includes at least one of:
a reward associated with completing an exchange for the card,
a discount offer associated with completing the exchange for the card, or a point offer to be applied to an account of a user associated with the device associated with completing the exchange for the card; and
wherein the one or more instructions, that cause the device to modify the document object model of the user interface, cause the device to:
modify the document object model of the user interface based on the presentation information to cause an indication of the incentive information to be provided for presentation via the user interface.

6. The non-transitory computer-readable medium of claim 1, wherein the one or more instructions, when executed by the one or more processors, further cause the device to:
receive, via the user interface, an input to initiate the first exchange using a credential associated with the card;
transmit, to a backend device, an indication of the first exchange and the credential associated with the card; and
receive, from the backend device, an indication that the first exchange was at least partially completed using resources associated with the card, wherein the resources associated with the card correspond to the actual amount associated with the card.

7. A method of modifying a document used to generate a web page to be provided for display by a device, comprising:
detecting, by a browser extension executing on the device, that the web page is associated with an entity and an exchange associated with the entity;
transmitting, by the browser extension and to a server, web page information that identifies at least one of:
the entity associated with the web page, or
an amount of the exchange associated with the entity;
receiving, by the browser extension and from the server, presentation information that identifies card information for one or more cards that are associated with the entity,
wherein card information associated with a card, of the one or more cards,
identifies information associated with resources associated with the card;
modifying, by the browser extension, the document used to generate the web page based on the presentation information, wherein modifying the document causes the card information for the one or more cards to be provided for display via the web page; and
displaying, by the device, the web page based on modifying the document used to generate the web page.

8. The method of claim 7, further comprising:
receiving a request to initiate a card exchange for a card of the one or more cards;
transmitting, to the server, an indication of card information for the card and an account to be used to complete the card exchange;
receiving, from the server, an indication that the card exchange has been completed and an indication of a credential of the card; and
modifying the document used to generate the web page to cause the credential of the card to be provided for display via the web page.

9. The method of claim 8, wherein modifying the document used to generate the web page to cause the credential of the card to be provided for display via the web page comprises:
inserting code into the document used to generate the web page that causes the credential of the card to be displayed in a payment field of the web page.

10. The method of claim 7, further comprising:
receiving a request to initiate the exchange associated with the entity using a card of the one or more cards;
transmitting, to a transaction backend, an indication of exchange information for the exchange associated with the entity, wherein the exchange information indicates at least one of:
the entity associated with the exchange,
the amount of the exchange,
a credential of the card, or
a balance of the card; and
receiving, from the transaction backend, an indication that the exchange has been at least partially completed using resources of the card; and
modifying the document used to generate the web page to cause an updated amount of the exchange to be displayed via the web page, wherein the updated amount of the exchange is based on a difference between the amount of the exchange and the balance of the card.

11. The method of claim 7, wherein transmitting, to the server, the web page information causes the server to identify the one or more cards based on the web page information in a data structure stored by the server.

12. A system, comprising:
one or more memories; and
one or more processors, communicatively coupled to the one or more memories, configured to:
receive, from a web browser extension executing on a first client device, information that identifies:
an entity associated with a graphical user interface being presented for display by a web browser executing on the first client device, and
transaction information that is being presented for display by the web browser;
identify one or more cards based on the information using a data structure that stores card information, wherein the one or more cards are associated with users that are different than a user of the first client device;
determine, from the one or more cards, a card to be provided to the first client device; and
transmit, to the first client device, card information that identifies information associated with resources of the card.

13. The system of claim 12, wherein the one or more processors are further configured to:
receive, from a second client device, information associated with a card to be made available for purchase, wherein the information associated with the card identifies at least one of:
one or more entities associated with the card,
a credential associated with the card, or
a balance of the card; and
storing the information associated with the card in the data structure.

14. The system of claim 13, wherein the one or more processors are further configured to:
complete a transaction for the card to be made available for purchase after receiving the information associated with the card or after the card to be made available for purchase is purchased by an entity, wherein completing the transaction for the card causes resources to be provided to an account associated with a user of the second client device, and wherein an amount of the resources to be provided to the account is based on the balance of the card.

15. The system of claim 12, wherein the one or more processors are further configured to:
monitor the card information stored in the data structure;
determine that card information for a card stored in the data structure should be updated; and
update the card information for the card in the data structure.

16. The system of claim 12, wherein the one or more processors, when identifying the one or more cards based on the information, are configured to:
identify a set of cards, using the data structure, based on the entity associated with the graphical user interface being presented for display by the web browser; and
identify the one or more cards, from the set of cards, based on an amount indicated by the transaction information that is being presented for display by the web browser, wherein the one or more cards have balances that are less than or equal to the amount indicated by the transaction information.

17. The system of claim 12, wherein the one or more processors, when determining the card to be provided to the first client device, are configured to:
determine a card, from the one or more cards, that has:
a balance that is closest to an amount indicated by the transaction information that is being presented for display by the web browser, or
a greatest savings amount associated with the card.

18. The system of claim 12, wherein the one or more processors, when determining the card to be provided to the first client device, are configured to:
determine that multiple cards, from the one or more cards, have a balance that is closest to an amount indicated by the transaction information that is being presented for display by the web browser or a greatest savings amount associated with the multiple cards; and
determine the card to be provided to the first client device, from the one or more cards, based on an amount of time that the multiple cards have been stored in the data structure.

19. The system of claim 12, wherein the one or more processors are further configured to:
initiate a purchase for the card using resources of the first account, wherein an amount of the resources is based on the cost of the card; and
perform an action associated with a transaction associated with the transaction information, wherein the action includes:
transmitting, to the first client device, a credential of the card that enables the first user to complete transactions using the card, or
communicating, with a backend device, to cause the transaction to be at least partially completed using the resources associated with the card.

20. The system of claim 12, wherein the one or more processors are further configured to:
identify, using the data structure, a second user associated with the card; and
provide, to a second account associated with the second user, resources based on completing the purchase for the card using resources of the first account, wherein an amount of the resources provided to the second account is based on the amount of the resources of the first account used to complete the purchase for the card.
